(19) United States
(12) Patent Application Publication
(10) Pub. No.: US 2025/0262891 A1
(43) Pub. Date: Aug. 21, 2025

(54) VEHICLE WHEEL BEARING INCLUDING SENSOR ASSEMBLY HAVING SEALING PORTION

(71) Applicant: ILJIN GLOBAL CO.,LTD., Seoul (KR)

(72) Inventors: Kyeong Hyeon KIM, Seoul (KR); Hyung Joo LEE, Seoul (KR); Man Chul LEE, Seoul (KR); Sun Ki CHO, Seoul (KR); Gui Bong JANG, Seoul (KR); Young Tae KIM, Seoul (KR); Ha Seok OH, Seoul (KR); Min Chul PARK, Seoul (KR); Nam Gyu HA, Seoul (KR); Seok Woo LEE, Seoul (KR); Jae Nam SHIN, Seoul (KR)

(73) Assignee: ILJIN GLOBAL CO., LTD., Seoul (KR)

(21) Appl. No.: 19/184,619

(22) Filed: Apr. 21, 2025

Related U.S. Application Data
(63) Continuation of application No. PCT/KR2023/016511, filed on Oct. 23, 2023.

(30) Foreign Application Priority Data
Oct. 21, 2022 (KR) 10-2022-0136894

(51) Int. Cl. B60B 27/00; F16J 15/447; G01P 3/44

(52) U.S. Cl. CPC B60B 27/0068; B60B 27/0073; B60B 27/0094; F16J 15/447; G01P 3/443; B60B 2900/511

(57) ABSTRACT

A vehicle wheel bearing includes a wheel hub provided with a wheel-mounting flange; an inner ring mounted on an outer circumferential surface of the wheel hub; an outer ring provided with a vehicle body-side mounting flange; a plurality of rolling elements for rotatably supporting the wheel hub and the inner ring relative to the outer ring; an outboard-side sealing member that seals a space between the wheel hub and the outer ring; a target ring mounted on one side of the inner ring and rotating together with the inner ring; and a sensor assembly that detects information about operating state(s) of a vehicle. The sensor assembly may comprise a wheel speed sensing portion that detects a change in a magnetic field generated by a sensor target of a target ring that rotates together with the vehicle wheel and measures the rotation speed of the wheel.

### CROSS-REFERENCE TO RELATED APPLICATIONS

This application is a continuation of International Application No. PCT/KR2023/016511 filed on Oct. 23, 2023, which claims priority to Korean Patent Application No. 10-2022-0136894 filed on Oct. 21, 2022, the entire contents of which are herein incorporated by reference.

### TECHNICAL FIELD

The present disclosure relates to a vehicle wheel bearing including a sensor assembly that detects an operating state(s) of a vehicle, and more particularly, to a vehicle wheel bearing configured to include a sealing portion for performing a sealing function in a sensor assembly.

### BACKGROUND ART

A wheel bearing is a device for rotatably mounting and supporting a vehicle wheel to a vehicle body, and may be divided into a wheel bearing mounted on an driving wheel of a vehicle and a wheel bearing mounted on an driven wheel of a vehicle.

Referring to FIG. 1, an example of a vehicle wheel bearing used in the related arts is shown as an example.

As shown in FIG. 1, the wheel bearing 10 may be configured so that a rotating element on which a wheel is mounted [for example, wheel hub 20 and inner ring 30] is coupled to a non-rotating element [for example, outer ring 40] that is fixed to a vehicle body through rolling elements 50, and thus a vehicle wheel can be rotatably mounted relative to the vehicle body, and a wheel speed sensor 60 may be provided on one side of the wheel bearing 10 to detect a rotational speed of the wheel.

Conventionally, the wheel speed sensor 60 may be configured such that a sensing portion 64 is positioned adjacent to a sensor target 70 (for example, encoder), which is mounted to a rotating element [for example, inner ring 30] and rotating together with the wheel, and may be configured to detect a rotational speed of the wheel by detecting changes in the magnetic field generated by the rotating sensor target 70. In addition, the rotational speed information of the wheel detected through the wheel speed sensor 60 may be transmitted to the ECU or the like of the vehicle, and may be used for operating control systems such as ABS or ECS.

Meanwhile, the wheel speed sensor 60 may be formed to have a structure in which the sensing portion 64 is provided in a housing 62 mounted on one side of the wheel bearing, and may be configured to detect a rotational speed of the wheel by detecting changes in a magnetic field caused by the rotation of the sensor target 70 through the sensing portion 64. In addition, a terminal portion(s) extending from or coupled to the sensing portion 64 may be configured to be exposed to the outside through a connector portion formed in the housing 62 and coupled to a cable or the like to transmit the detected rotation speed information to an external control device or the like.

### DISCLOSURE

### Technical Problem

The present disclosure is for the purpose of providing a vehicle wheel bearing, which is a wheel bearing including a sensor assembly, configured to prevent foreign substances from being introduced into the wheel bearing even without installing a separate sealing member by integrally providing a sealing portion to a sensor assembly (for example, a wheel speed sensor).

### Technical Solution

Representative configurations of the present disclosure for achieving the above- described purpose are as follows.

According to an example embodiment of the present disclosure, a vehicle wheel bearing for rotatably mounting and supporting a vehicle wheel to a vehicle body is provided. The vehicle wheel bearing according to an example embodiment of the present disclosure may be configured to comprise a wheel hub provided with a wheel-mounting flange; an inner ring mounted on an outer circumferential surface of the wheel hub; an outer ring provided with a vehicle body-side mounting flange; a plurality of rolling elements for rotatably supporting the wheel hub and the inner ring relative to the outer ring; an outboard-side sealing member that seals a space between the wheel hub and the outer ring; a target ring mounted on one side of the inner ring and rotating together with the inner ring; and a sensor assembly that detects information about operating state(s) of a vehicle. According to an example embodiment of the present disclosure, the sensor assembly may comprise a wheel speed sensing portion that detects a change in a magnetic field generated by a sensor target of a target ring that rotates together with the vehicle wheel and measures the rotation speed of the wheel, and one side of the sensor assembly is provided with a sealing portion for preventing introduction of foreign substances.

According to an example embodiment of the present disclosure, the sensor assembly may be formed as a sensor cap structure which is mounted and fixed on one side of the outer ring.

According to an example embodiment of the present disclosure, the sensor assembly may comprise a press-fit ring mounted on an outer circumferential surface or an inner circumferential surface of the outer ring, and the sealing portion may be provided on one side of the press-fitting ring.

According to an example embodiment of the present disclosure, the sealing portion may comprise a base portion attached to one side of the press-fit ring and one or more sealing lips formed by extending from the base portion.

According to an example embodiment of the present disclosure, the sealing lip may be formed as a contact-type sealing lip.

According to an example embodiment of the present disclosure, the sealing portion may be configured to be integrally formed by vulcanization on one side of the press-fitting ring.

According to an example embodiment of the present disclosure, the press-fit ring may comprise a mounting portion that is press-fitted to the outer circumferential surface or the inner circumferential surface of the outer ring; a radial extension portion that extends in a radial direction from the mounting portion; and an axial extension portion that is bent and extends in the axial direction from the radial extension portion, and a labyrinth structure for preventing introduction of foreign substances from an outside may be formed by the axial extension portion.

According to an example embodiment of the present disclosure, the base portion of the sealing portion attached to the axial extension portion of the press-fit ring may be configured to be positioned adjacent to the wheel hub or a washer member mounted thereto to form a labyrinth structure therebetween.

According to an example embodiment of the present disclosure, the target ring may comprise a frame mounted on the inner ring; and a sensor target attached to the frame, the frame of the target ring may comprise a mounting portion that is press-fitted to an outer circumferential surface of the inner ring; a radial extension portion that extends in the radial direction from the mounting portion; and an axial extension portion that is bent and extends in the axial direction from the radial extension portion, and the base portion of the sealing portion attached to the axial extension portion of the press-fit ring may be configured to be adjacent to the axial extension portion of the frame of the target ring to form a labyrinth structure therebetween.

According to an example embodiment of the present disclosure, a step portion having a radially concave recess structure may be provided on one side of the base portion of the sealing portion, and the axial extension portion of the frame of the target ring may be disposed to be accommodated in the step portion.

According to an example embodiment of the present disclosure, the sensor target may be configured to be provided in the mounting portion of the frame, and the sealing lip of the sealing portion may be configured to be located inward in the radial direction from the sensor target.

According to an example embodiment of the present disclosure, the sensor assembly may further comprise an acceleration sensing portion that detects acceleration information of the vehicle.

According to an example embodiment of the present disclosure, the acceleration sensing portion may comprise an acceleration sensor that detects acceleration information of the vehicle, and the acceleration sensor may be configured to be provided on a printed circuit board (PCB) substrate provided in the sensor assembly.

According to an example embodiment of the present disclosure, the acceleration sensor may be configured to be positioned further outward in an axial direction than an inner axial end of the wheel hub.

According to an example embodiment of the present disclosure, the acceleration sensor may be configured to be positioned outward in the radial direction from a vehicle body-side end of the outer ring on which the press-fitting ring is mounted.

In addition, the vehicle wheel bearing according to the present disclosure may further comprise other additional components as long as they do not harm the technical idea of the present disclosure.

### Advantageous Effects

A vehicle wheel bearing according to an example embodiment of the present disclosure is provided with a sealing portion in a sensor assembly so that the introduction of external foreign substances can be prevented even without providing a separate sealing member (inboard-side sealing member) on a vehicle body-side end of the wheel bearing, to which the sensor assembly is mounted adjacent thereto.

Also, since the vehicle wheel bearing according to an example embodiment of the present disclosure has the sealing portion in the sensor assembly, even when the sensor assembly is formed to have a ring-shaped structure in which a central portion thereof is hollow to open so that the sensor assembly can be used in a wheel bearing for a drive shaft, the introduction of external foreign substances can be prevented without a separate sealing member.

Furthermore, the vehicle wheel bearing according to an example embodiment of the present disclosure is configured so that a wheel speed sensing portion and an acceleration sensing portion are provided together in the sensor assembly so that various information about operating states of a vehicle can be obtained using one sensor assembly.

In addition, the vehicle wheel bearing according to an example embodiment of the present disclosure is configured so that the acceleration sensing portion provided in the sensor assembly is configured to be located outside an outer ring in a radial direction, thereby preventing the occurrence of interference with a counterpart part when assembling the wheel bearing and the sensor assembly to the vehicle and improving a freedom of design of the counterpart part.

### DESCRIPTION OF DRAWINGS

FIG. 1 exemplarily shows a vehicle wheel bearing provided with a wheel speed sensor.

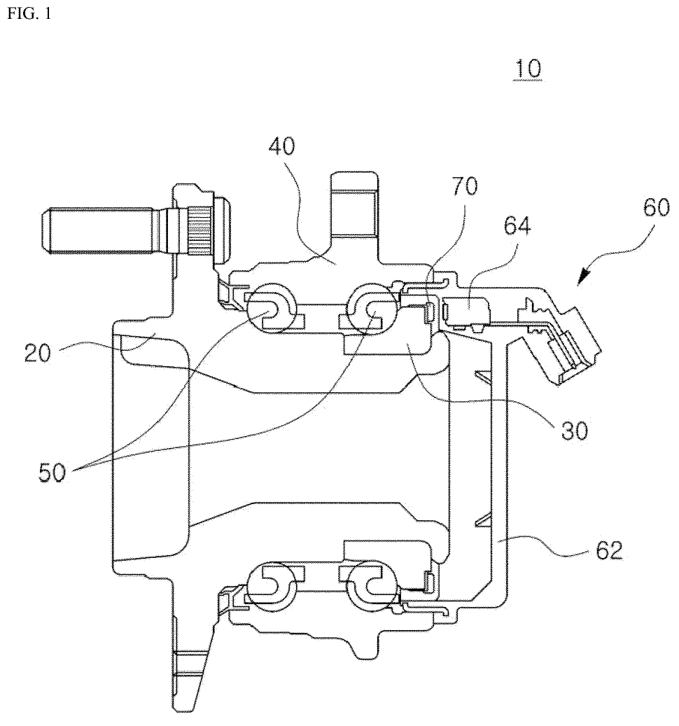

FIG. 2 exemplarily shows a structure of the vehicle wheel bearing (vehicle wheel bearing having a sensor assembly) according to an example embodiment of the present disclosure.

FIG. 3 exemplarily shows a partial cutaway view of the vehicle wheel bearing shown in FIG. 2.

FIG. 4 exemplarily shows a cross-sectional structure of the vehicle wheel bearing shown in FIGS. 2 and 3.

FIG. 5 exemplarily shows the sensor assembly of the vehicle wheel bearing shown in FIGS. 2 to 4.

FIG. 6 exemplarily shows an internal structure (structure in which a housing is omitted) of the sensor assembly shown in FIG. 5.

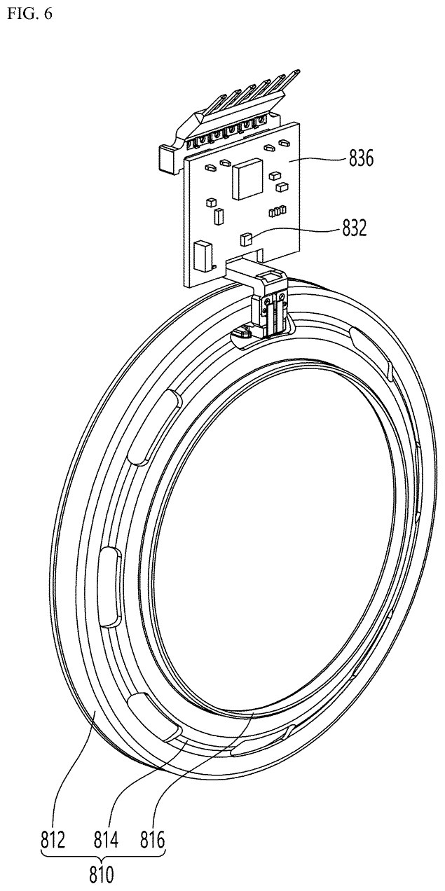

FIG. 7 exemplarily shows a press-fit ring of the sensor assembly shown in FIG. 5.

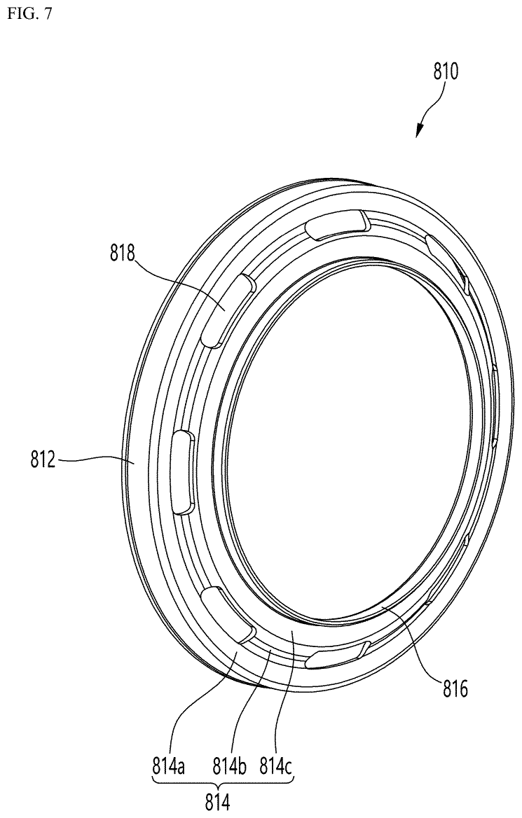

FIG. 8 exemplarily shows the internal structure (wheel speed sensor, lead frame, or the like) of the sensor assembly shown in FIG. 5.

FIG. 9 exemplarily shows the wheel speed sensor and the lead frame of the sensor assembly shown in FIG. 5.

FIG. 10 exemplarily shows a vehicle body-side end structure of the vehicle wheel bearing shown in FIGS. 2 to 4.

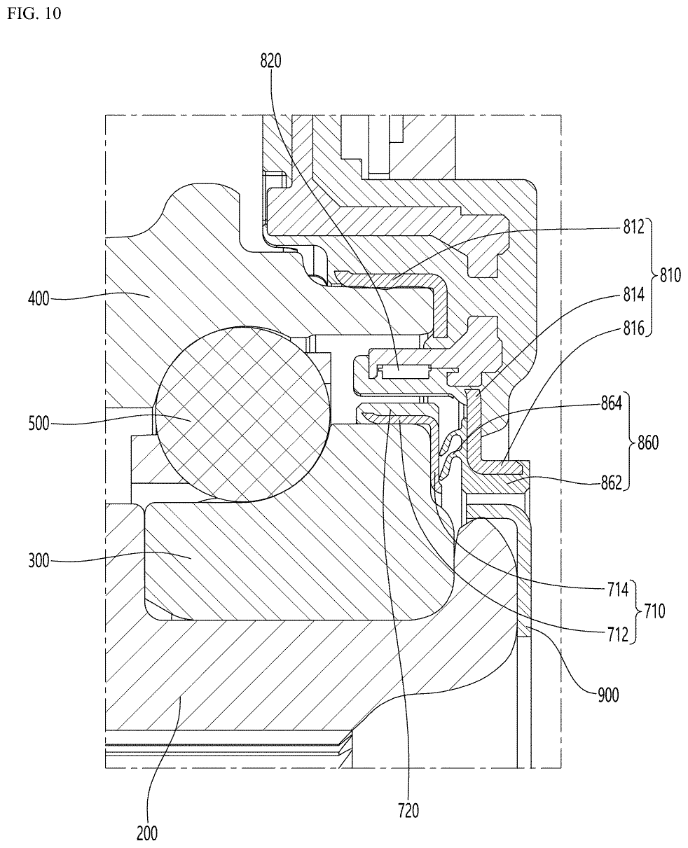

FIG. 11 exemplarily shows a vehicle body-side end structure of a vehicle wheel bearing according to another embodiment of the present disclosure.

### DETAILED DESCRIPTION

The example embodiments described below are provided for the purpose of describing the technical ideas of the present disclosure, and the scope of the rights of the present disclosure is not limited to the example embodiments presented below or the specific descriptions thereof.

All technical and scientific terms used in this specification, unless otherwise defined, have the meaning commonly understood by a person of ordinary skill in the art to which the present disclosure belongs, and all terms used in this specification have been selected for the purpose of more clearly describing the present disclosure and have not been selected to limit the scope of the rights of the present disclosure.

The expressions “comprising,” “including,” “having,” and the like used in this specification should be understood as open-ended terms implying the possibility of including other example embodiments, unless otherwise stated in the phrase or sentence in which the expression is included.

In this specification, “axial” means a direction extending along the rotational center axis of the wheel bearing (“axially inward” means a direction toward the vehicle body, and “axially outward” means a direction toward the wheel), “radial” means a direction perpendicular to the “axial direction” away from or closer to the rotational center axis, and “circumferential” means a direction of rotation centered on the above- described “axial direction.”

The singular forms used in this specification may include plural meanings unless otherwise stated, and the same applies to the singular forms used in the claims.

When it is described in this specification that a component is “located” or “formed” on one side of another component, it should be understood that the component can be located or formed in direct contact with one side of the other component, or can be located or formed with another new component interposed therebetween.

Hereinafter, a preferred example embodiment of the present disclosure is described in detail to the extent that a person skilled in the art to which the present disclosure belongs can easily practice the present disclosure with reference to the attached drawings. In the attached drawings, the same or corresponding components are indicated by the same reference numerals, and in the description of the example embodiments below, duplicate description of identical or corresponding components may be omitted. However, even when a description(s) of a particular component is omitted in the description below, it is not intended that this component is not included in the example embodiment.

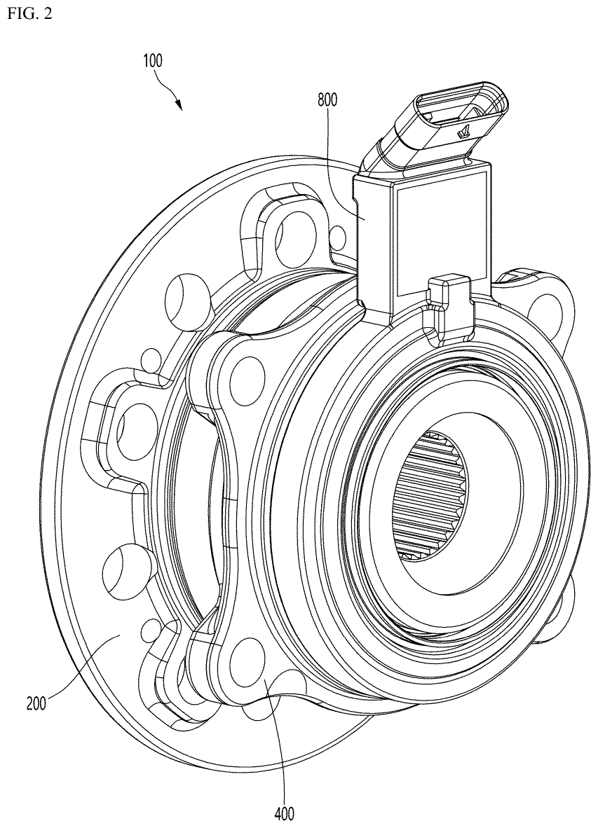

First, referring to FIGS. 2 to 4, a vehicle wheel bearing according to an example embodiment of the present disclosure is exemplarily shown. The vehicle wheel bearing according to an example embodiment of the present disclosure may be formed to have an overall structure similar to that of a vehicle wheel bearing in the related arts, and is characterized in that a sealing portion is provided on one side of a sensor assembly mounted on the wheel bearing, as described below, to perform a sealing function together with the sensor assembly.

Specifically, a vehicle wheel bearing 100 according to an example embodiment of the present disclosure may be configured so that a rotating element [for example, a wheel hub 200 and an inner ring 300] is coupled to a non-rotating element [for example, an outer ring 400] via rolling elements 500 as shown in the drawings to perform a function of rotatably supporting a vehicle wheel relative to a vehicle body.

According to an example embodiment of the present disclosure, the wheel hub 200 may be formed to have a generally cylindrical structure extending in an axial direction, and a wheel-mounting flange 210 (hub flange) may be provided on one outer circumferential surface of the wheel hub 200. The wheel-mounting flange 210 may be formed to have a shape radially extending outward from the outer circumferential surface of the wheel hub 200 and may be used for mounting the vehicle wheel to the wheel hub 200 using a hub bolt or the like. Meanwhile, the inner ring 300 may be configured to be mounted on a vehicle body-side end of the wheel hub 200, and a raceway surface (inner raceway surface) for rolling elements may be formed on a part of the outer circumferential surface of the wheel hub 200 to support the rolling elements 500 from an inner side in the radial direction.

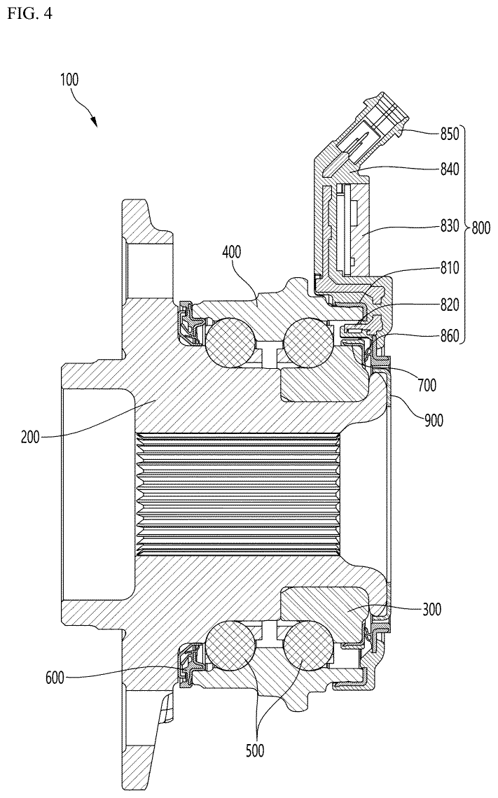

According to an example embodiment of the present disclosure, at least one inner ring 300 may be mounted on the outer circumferential surfaces of the wheel hub 200, and a raceway surface (inner raceway surface) for rolling elements may be formed on an outer circumferential surface of the inner ring 300 to support the rolling elements 500 from an inner side in the radial direction. For example, the inner ring 300 may be configured to be press-fitted and fixed to a mounting portion provided in the vicinity of the vehicle body-side end of the wheel hub 200, and may be configured to be supported/fixed on the wheel hub 200 by a forming portion 220 formed by plastically deforming the vehicle body-side end of the wheel hub 200 outward in the radial direction as shown in FIG. 4.

According to an example embodiment of the present disclosure, the outer ring 400 may be configured to comprise a vehicle body-side mounting flange 410, which is used for mounting the wheel bearing to the vehicle body, on an outer circumferential surface thereof, and raceway surfaces, with which the rolling elements 500 come into contact. The raceway surfaces (outer raceway surfaces) formed on the inner circumferential surface of the outer ring 400 may be configured to cooperate with the raceway surfaces (inner raceway surfaces) formed on the wheel hub 200 and/or the inner ring 300 to accommodate and support the rolling elements 500, which are rolling members, between these raceway surfaces.

According to an example embodiment of the present disclosure, the rolling elements 500 may be disposed between the rotating element [for example, the wheel hub 200 and/or the inner ring 300] of the wheel bearing 100 and the non-rotating element [for example, the outer ring 400] of the wheel bearing 100, and may perform a function of rotatably supporting the rotating element of the wheel bearing relative to the non-rotating element.

Although the wheel bearing of the example embodiment shown in the drawing is configured in a form in which one raceway surface for supporting the rolling elements is directly formed on a part of an outer circumferential surface of the wheel hub, the wheel bearing according to an example embodiment of the present disclosure is not necessarily limited to this structure, and may be modified and implemented to have various other structures, such as a configuration in which two inner rings are mounted on the wheel hub to support the rolling elements through two inner rings.

According to an example embodiment of the present disclosure, a sealing member 600 (outboard-side sealing member) may be mounted at an axial outer end portion of the wheel bearing 100 to prevent external foreign substances from being introduced into a bearing space where the rolling elements 500 are located.

According to an example embodiment of the present disclosure, a target ring 700 (for example, an encoder ring) used for measuring a rotational speed of the wheel may be provided at an axial inner end portion of the wheel bearing 100.

According to an example embodiment of the present disclosure, the target ring 700 may be configured to be mounted on the rotating element [for example, the inner ring 300] of the wheel bearing 100 and rotate together with the vehicle wheel.

According to an example embodiment of the present disclosure, the target ring 700 may be configured to comprise a frame 710 press-fitted and mounted to the rotating element [for example, the inner ring 300] of the wheel bearing 100 and a sensor target 720 (for example, an encoder) attached to the frame 710.

According to an example embodiment of the present disclosure, the frame 710 of the target ring 700 can be configured to comprise a mounting portion 712 press-fitted to an outer circumferential surface of the inner ring 300; and a radial extension portion 714 extending inward in the radial direction from the mounting portion 712.

According to an example embodiment of the present disclosure, the sensor target 720 (for example, an encoder) may be configured to be integrally formed on one side of the frame 710. For example, in the example embodiment shown in the drawing, the target ring 700 is configured so that the sensor target 720 is integrally formed on an outer circumferential surface of the mounting portion 712 of the frame 710.

According to an example embodiment of the present disclosure, the sensor target 720 may be configured to generate changes in the magnetic field while rotating together with the inner ring 300, and the sensor assembly 800, which will be described below, may be configured to detect a rotational speed of the wheel by detecting the changes in the magnetic field through a wheel speed sensing portion 820.

According to an example embodiment of the present disclosure, the sensor assembly 800 may be provided on one side of the wheel bearing 100 and configured to detect information about the operating state(s) of the vehicle, such as the rotational speed of the wheel.

According to an example embodiment of the present disclosure, the sensor assembly 800 may be configured to be installed at the axial inner end of the wheel bearing 100, and may be configured to be fixedly mounted on the outer ring 400 or a chassis member or the like on which the outer ring 400 is mounted.

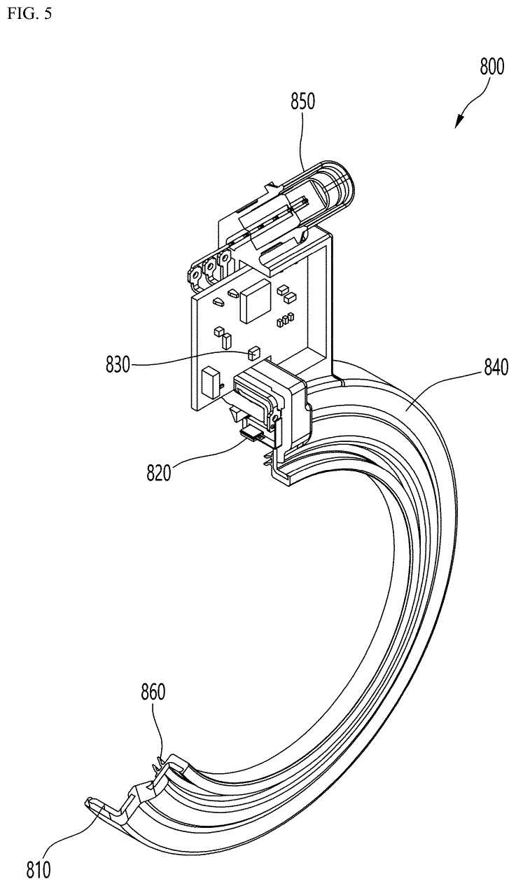

According to an example embodiment of the present disclosure, the sensor assembly 800 may be formed as a cap-type structure in which the sensor assembly 800 is press-fitted and mounted on the axial inner end of the outer ring 400, and may be formed as a ring-shaped structure in which a central portion thereof is hollow to open so that the sensor assembly 800 can also be used for a wheel bearing for a driving shaft. (refer to FIGS. 4 and 5)

According to an example embodiment of the present disclosure, the sensor assembly 800 may be configured to comprise a press-fit ring 810 and may be configured to be press-fitted and mounted to an outer circumferential surface or an inner circumferential surface of the outer ring 400 via press-fit ring 810.

According to an example embodiment of the present disclosure, the press-fit ring 810 may be configured to comprise a mounting portion 812 coupled to an outer circumferential surface or an inner circumferential surface of the outer ring 400; a radial extension portion 814 extending in the radial direction from the mounting portion 812; and an axial extension portion 816 bent and extending in the axial direction from the radial extension portion 814.

According to an example embodiment of the present disclosure, the mounting portion 812 of the press-fit ring 810 is a portion that is press-fitted and coupled to the outer circumferential surface or the inner circumferential surface of the outer ring 400. In addition, in the case of the example embodiment shown in the drawings, the sensor assembly 800 may be configured to be press-fitted and coupled to the outer circumferential surface of the outer ring by the press-fit ring 810.

According to an example embodiment of the present disclosure, the radial extension portion 814 may be configured to comprise a first radial extension portion 814a that is bent and extends from the mounting portion 812; a coupling portion 814b that is bent and extends from the first radial extension portion 814a; and a second radial extension portion 814c that is bent and extends from the coupling portion 814b, as shown in the drawings.

According to this structure, since the first radial extension portion 814a and the second radial extension portion 814b may be positioned spaced in the axial direction from each other through the coupling portion 814b, even when the press-fit ring 810 is mounted on the outer ring 400 so that the first radial extension portion 814a comes into contact with an axial end surface of the outer ring 400, the press-fit ring 810 may be prevented from interfering with the inner ring 300.

According to an example embodiment of the present invention, the wheel speed sensing portion 820 used for detecting the rotation speed of the vehicle wheel may be provided in the sensor assembly 800.

According to an example embodiment of the present disclosure, the wheel speed sensing portion 820 may comprise a wheel speed sensor 822 that detects the rotation speed of the wheel, and the wheel speed sensor 822 may perform a function of detecting the rotation speed of the wheel by detecting changes in the magnetic field generated by the rotation of the sensor target 720.

According to an example embodiment of the present disclosure, the wheel speed sensor 822 provided in the wheel speed sensing portion 820 may be formed as a Hall sensor, an anisotropic magneto resistance (AMR) sensor, a giant magneto resistance (GMR) sensor, or the like, similar to a wheel speed sensor for conventional vehicles.

According to an example embodiment of the present disclosure, the wheel speed sensor 822 may be configured to be disposed opposite to the sensor target 720 provided in the target ring 700 inward and outward in the radial direction. For example, in the case of the example embodiment shown in the drawings, the wheel speed sensing portion 820 may be inserted and coupled through a through hole 818 provided in the press-fit ring 810 so that the wheel speed sensor 822 is configured to be disposed to face the sensor target 720.

According to an example embodiment of the present disclosure, the wheel speed sensor 822 may comprise a lead terminal 822a extending outward and may be configured to electrically connect the wheel speed sensor 822 to an external power supply and control device via the lead terminal 822a.

According to an example embodiment of the present disclosure, the lead terminal 822a provided in the wheel speed sensor 822 may be configured to have a plurality of terminals including a power terminal(s) for supplying power and a signal terminal(s) for transmitting a signal.

According to an example embodiment of the present disclosure, the lead terminal 822a provided in the wheel speed sensor 822 may be configured to be electrically connected to an external power supply and/or control device via a conductive terminal portion 824.

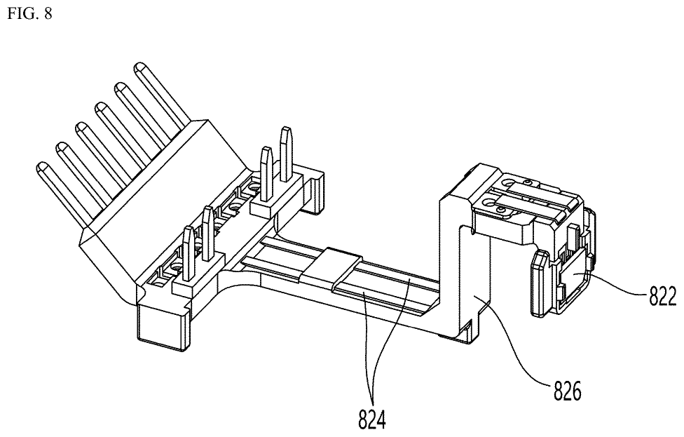

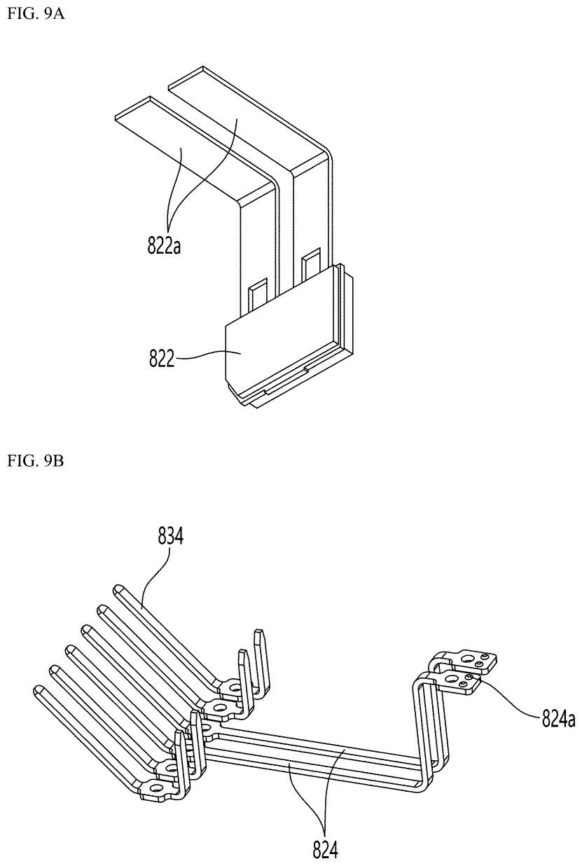

According to an example embodiment of the present disclosure, the conductive terminal portion 824 may be formed in the shape of a pair of thin and long metal plates as shown in FIGS. 8 and 9, and may be configured to have a plurality of terminals including a power terminal for transmitting power and a signal terminal for transmitting a signal.

According to an example embodiment of the present disclosure, as shown in FIGS. 8 and 9, the conductive terminal portion 824 may be configured so that one end thereof is electrically connected to the lead terminal 822a provided in the wheel speed sensor 822, and the other end thereof is exposed to the outside through a connector portion 850 to be electrically connected to an external power supply or control device through a connection connector or the like.

Meanwhile, one end of the conductive terminal portion 824 may comprise a protrusion portion 824a to be configured to more easily come into contact with the lead terminal 822a of the wheel speed sensor 822, and a plurality of terminals provided on the conductive terminal portion 824 may be formed in substantially the same or similar shapes.

However, the conductive terminal portion 824 is not limited to being formed in the above-described structure, and may be formed in various arbitrary shapes that may be electrically connected to the wheel speed sensor 822, and a plurality of terminals (power terminals and signal terminals) may be formed in different shapes.

In addition, although the wheel speed sensor and the conductive terminal portion are configured to be formed separately and then electrically connected in the example embodiment shown in the drawings, the wheel speed sensor may be configured so that the longer lead terminal of the wheel speed sensor extend and the wheel speed sensing portion is formed without the conductive terminal portion (that is, the wheel speed sensor and the conductive terminal portion are formed integrally).

According to an example embodiment of the present disclosure, the wheel speed sensor 822 and the conductive terminal portion 824, which constitute the wheel speed sensing portion 820, may be configured to be mounted and supported on an insert body portion 826 (refer to FIG. 8).

According to an example embodiment of the present disclosure, the insert body portion 826 may be formed using a method such as plastic injection molding, and may be configured to surround all or a part of the wheel speed sensor 822 and/or the conductive terminal portion 824.

For example, the wheel speed sensing portion 820 may be configured to be formed by injection molding the insert body portion 826 together with the conductive terminal portion 824 and then electrically connecting the wheel speed sensor 822 to the conductive terminal portion 824, or may be configured to be formed by injection molding the insert body portion 826 at a state that the wheel speed sensor 822 and the conductive terminal portion 824 are electrically connected.

According to an example embodiment of the present invention, the sensor assembly 800 may be configured to further comprise an acceleration sensing portion 830 that detects acceleration information (vibration information) of a traveling vehicle.

According to an example embodiment of the present disclosure, the accelerating sensing portion 830 may be disposed spaced apart from the wheel speed sensing portion 820 described above, thereby simplifying the structure of the sensor assembly 800 and preventing signal interference that may occur between the wheel speed sensing portion 820 and the acceleration sensing portion 830.

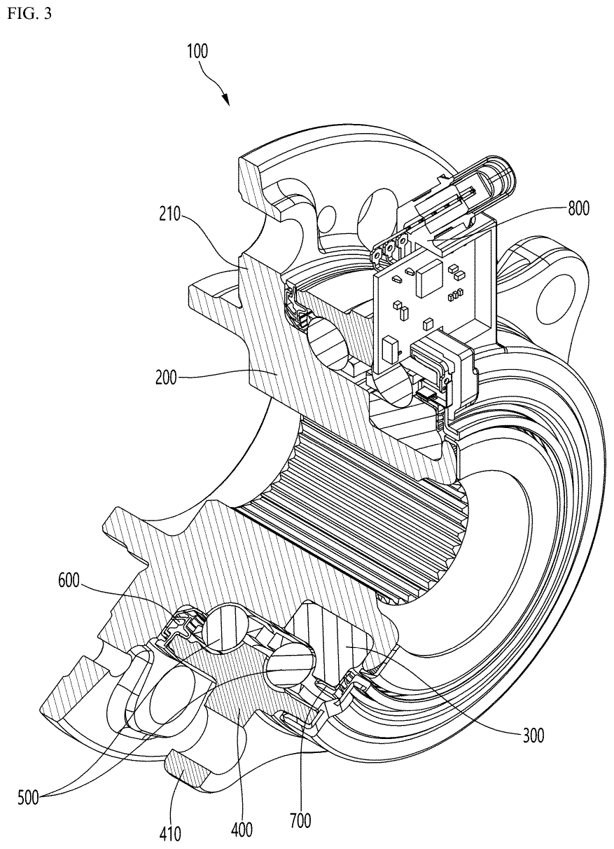

According to an example embodiment of the present disclosure, the acceleration sensing portion 830 may comprise one or more acceleration sensors 832 that detect acceleration information (vibration information) of the vehicle, and the acceleration sensor 832 may be configured to be mounted on a printed circuit board (PCB) substrate 836 provided in the sensor assembly 800 as shown in FIGS. 3 and 5.

According to an example embodiment of the present disclosure, the acceleration sensor 832 provided in the acceleration sensing portion 830 may be configured as any one of a one-axis acceleration sensor capable of measuring acceleration in one of the mutually perpendicular x, y, and z-axis directions, a two-axis acceleration sensor capable of measuring acceleration in two directions, or a three-axis acceleration sensor capable of measuring acceleration in all three directions. In addition, acceleration information measured from the acceleration sensors may be configured to be used to diagnose the operating state of chassis components or wheel bearings of a vehicle, to eliminate noise generated while the vehicle is driving, or to control the driving of the vehicle.

According to an example embodiment of the present disclosure, the acceleration sensor 832 may be configured to be positioned outward in the axial direction relative to the inner axial end of the wheel hub 200 [for example, in the case of the example embodiment shown in the drawings, the axial end portion of the forming portion 220 provided at the inner axial end of the wheel hub 200].

According to an example embodiment of the present disclosure, it may be preferable that the acceleration sensor 832 be configured to be positioned outward in the radial direction from the vehicle body-side end of the outer ring 400 on which the press-fit ring 810 is mounted.

According to an example embodiment of the present disclosure, it may be more preferable that the acceleration sensing portion 830 be configured to be positioned outward in the radial direction from the mounting portion 812 of the press-fit ring 810 mounted on the outer ring 400.

According to an example embodiment of the present disclosure, the sensor assembly 800 may be configured so that at least a part of the connector portion 850 is positioned outward in the radial direction from the vehicle body-side end of the outer ring 400 to which the press-fit ring 810 is mounted.

In this way, since the sensor assembly 800 of the vehicle wheel bearing 100 according to an example embodiment of the present disclosure is configured so that the acceleration sensor 832 is positioned outward in the radial direction from the outer ring 400, the sensor assembly 800 may not extend in the axial direction toward the vehicle body as much as the wheel bearing 100, thereby reducing the risk of interference with the counterpart part when assembling the wheel bearing (and sensor assembly) to the vehicle and improving the freedom of design of the counterpart part.

According to an example embodiment of the present disclosure, it may be preferable that the acceleration sensor 832 be configured to be positioned adjacent to the mounting portion 812 of the press-fit ring 810.

In this way, shaking of the sensor may be prevented by arranging the acceleration sensor 832 adjacent to the mounting portion 812 of the press-fit ring 810 that supports the mounting of the sensor assembly 800, thereby preventing distortion of the vibration signal, and thus enabling easier and more accurate detection of vibration information.

According to an example embodiment of the present disclosure, the acceleration sensor 832 may be configured to be disposed on the PCB substrate 836 provided in the sensor assembly 800.

According to an example embodiment of the present disclosure, the PCB substrate 836 may be configured to be disposed perpendicular to the rotational axis of the wheel bearing 100 so that the sensor assembly 800 is formed in a more compact structure. (refer to FIGS. 3 and 5)

According to an example embodiment of the present disclosure, the acceleration sensing portion 830 may comprise a conductive terminal portion 834 and may be configured to electrically connect the acceleration sensor 832 to an external power supply and/or control device via conductive terminal portion 834.

According to an example embodiment of the present disclosure, the conductive terminal portion 834 of the acceleration sensing portion 830 may be formed similarly to the conductive terminal portion 824 of the wheel speed sensing portion 820 described above. For example, the conductive terminal portion 834 may be configured to be formed in a thin and long metal plate shape, and may be configured to have a plurality of terminals including a power terminal for transmitting power and a signal terminal for transmitting a signal.

According to an example embodiment of the present disclosure, one end of the conductive terminal portion 834 may be connected to the PCB substrate 836 and electrically connected to the acceleration sensor 832 mounted on the PCB substrate 836 through a circuit pattern (not shown) formed on the PCB substrate 836, and the other end of the conductive terminal portion 834 may be exposed to the outside through the connector portion 850 and configured to be electrically connected to an external power supply, a control device, or the like through a connection connector and/or cable.

According to an example embodiment of the present disclosure, the sensor assembly 800 may be configured so that all or a part of the wheel speed sensor 822, the acceleration sensor 832, the conductive terminal portions 824 and 834, and the like are surrounded and protected by a housing 840, and the housing 840 of the sensor assembly 800 may be configured to be formed through plastic injection molding or the like.

According to an example embodiment of the present disclosure, the housing 840 may perform a function of forming a basic body of the sensor assembly 800, and the connector portion 850 may be provided on one side of the housing 840 to electrically connect the wheel speed sensor 822 and the acceleration sensor 832 provided in the sensor assembly 800 to an external power supply or control device.

According to an example embodiment of the present disclosure, the sensor assembly 800 may comprise a sealing portion 860 for preventing the introduction of external foreign substances.

According to an example embodiment of the present disclosure, the sealing portion 860 may be configured to be provided on one side of the press-fit ring 810. For example, the sealing portion 860 may be configured to be provided on the axial extension portion 816 and/or the radial extension portion 814 of the press-fit ring 810.

According to an example embodiment of the present disclosure, the sealing portion 860 may be configured to comprise a base portion 862 attached to one side of the press-fit ring 810; and one or more sealing lips 864 formed to extend from the base portion 862.

According to an example embodiment of the present disclosure, the sealing lip 864 provided in the sealing portion 860 may be configured as a contact-type side lip that performs sealing by coming into contact with the axial end surface of a counterpart member.

According to an example embodiment of the present disclosure, the sealing lip 864 provided in the sealing portion 860 may be configured to perform sealing by coming into contact with the axial end surface of the radial extension portion 714 of the frame 710 of the target ring 700.

According to an example embodiment of the present disclosure, the sealing lip 864 provided on the sealing portion 860 may be configured so that the sealing lip 864 comes into contact with a predetermined interference amount when the press-fit ring 810 of the sensor assembly 800 is mounted on the outer ring 400.

According to an example embodiment of the present disclosure, the sealing portion 860 may be configured to be positioned inward in the axial direction relative to the sensor target 720, and more preferably, to be positioned inward in the radial direction relative to the sensor target 720.

According to this structure, the wheel bearing 100 according to an example embodiment of the present disclosure may perform a sealing function by the sealing portion 860 provided in the sensor assembly 800 even without a separate sealing member (inboard-side sealing member) provided at the vehicle body-side end, thereby simplifying the structure and assembly process of the wheel bearing 100.

Particularly, since the wheel bearing 100 according to an example embodiment of the present disclosure is configured so that the sealing lip 860 provided to the sensor assembly 800 has a contact-type sealing lip 864 on the radially inner side, compared to the inboard-side sealing member provided to a conventional wheel bearing, the diameter of the contact-type sealing lip 864 is reduced compared to a sealing member in the related art, and thus, a contact area of the contact-type sealing lip 864 is reduced so that the drag torque generated by the contact-type sealing lip 864 during operation of the vehicle may be reduced.

According to an example embodiment of the present disclosure, the sealing portion 860 may be integrally formed on one side of the press-fit ring 810 through vulcanization or the like.

For this purpose, the sensor assembly 800 according to an example embodiment of the present disclosure may be configured so that an end portion of the press-fit ring 810 is exposed to the outside of the housing 840 [in the case of the example embodiment shown in the drawings, end portion of the radial extension portion 814 and the axial extension portion 816 of the press-fit ring 810 are configured to be exposed to the outside of the housing 840], and the sealing portion 860 may be configured to be integrally formed with the portion of the press-fit ring 810 exposed to the outside of the housing 840.

According to an example embodiment of the present disclosure, the axial extension portion 816 of the press-fit ring 810 may be disposed adjacent to the wheel hub [for example, the forming portion 220 provided at the axial inner end of the wheel hub 200] or a washer member 900 mounted thereon, to form a labyrinth structure between the base portion 862 of the sealing portion 860 attached to the axial extension portion 816 of the press-fit ring 810 and the wheel hub (or a washer member mounted thereon).

In this way, when a labyrinth structure is formed on the upper side of the sealing portion 860, the introduction of foreign substances from the outside may be more stably suppressed by the labyrinth structure, which may be advantageous in securing sealing properties.

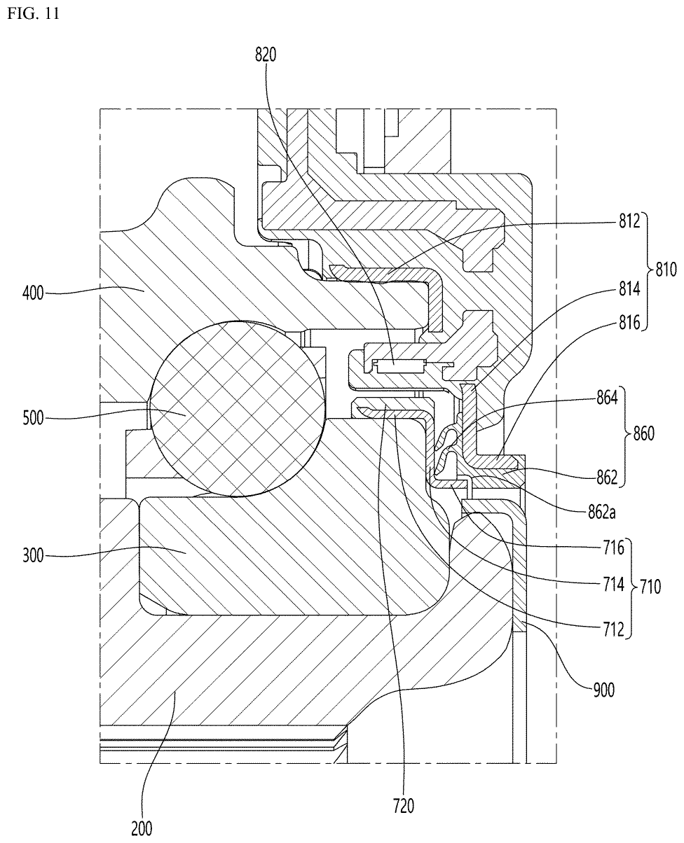

Meanwhile, according to an example embodiment of the present disclosure, the target ring 700 may be configured to further comprise an axial extension portion 716 that is bent and extends from the radial extension portion 714 at an end portion thereof (for example, refer to the example embodiment shown in FIG. 11), to form a narrower labyrinth structure between the base portion 862 of the sealing portion 860 attached to the axial extension portion 816 of the press-fit ring 810 and the axial extension portion 716 of the frame 710 of the target ring 700, thereby improving sealing performance.

According to an example embodiment of the present disclosure, the base portion 862 of the sealing portion 860 may comprise a step portion 862a having a radially concave recess structure at one side thereof, and the axial extension portion 716 of the frame 710 of the target ring 700 may be accommodated in and disposed adjacent to the step portion 862a. (refer to FIG. 11), to further maximize the labyrinth effect.

Although the present disclosure has been described with specific details such as specific components and limited examples, the examples are provided only to help a more general understanding of the present disclosure, and the present disclosure is not limited thereto, and a person having ordinary knowledge in the technical field to which the present disclosure belongs may make various modifications and variations from this description.

Therefore, the idea of the present disclosure should not be limited to the example embodiments described above, and not only the claims described below but also all modifications equivalent to or equivalent to the claims are considered to fall within the scope of the idea of the present disclosure.

### REFERENCE SIGNS LIST

100: wheel bearing
200: wheel hub
210: wheel-mounting flange
220: forming portion
300: inner ring
400: outer ring
410: vehicle body-side mounting flange
500: rolling element
600: outboard-side sealing member
700: target ring
710: frame
720: encoder
800: sensor assembly
810: press-fitting ring
820: wheel speed sensing portion
830: acceleration sensing portion
840: housing
850: connector portion
860: sealing portion
862: base portion
864: sealing lip

What is claimed is:

1. A vehicle wheel bearing (100) for rotatably mounting and supporting a vehicle wheel to a vehicle body, comprising:
a wheel hub (200) provided with a wheel-mounting flange (210);
an inner ring (300) mounted on an outer circumferential surface of the wheel hub (200);
an outer ring (400) provided with a vehicle body-side mounting flange (410);
a plurality of rolling elements (500) for rotatably supporting the wheel hub (200) and the inner ring (300) relative to the outer ring (400);
an outboard-side sealing member (600) that seals a space between the wheel hub (200) and the outer ring (400);
a target ring (700) mounted on one side of the inner ring (300) and rotating together with the inner ring (300); and
a sensor assembly (800) that detects information about operating state(s) of a vehicle,
wherein the sensor assembly (800) comprises a wheel speed sensing portion (820) that detects a change in a magnetic field generated by a sensor target (720) of a target ring (700) that rotates together with a vehicle wheel and measures the rotation speed of the wheel, and
wherein one side of the sensor assembly (800) is provided with a sealing portion (860) for preventing introduction of foreign substances.

2. The vehicle wheel bearing of claim 1, wherein the sensor assembly (800) is formed as a sensor cap structure which is mounted and fixed on one side of the outer ring (400).

3. The vehicle wheel bearing of claim 2, wherein the sensor assembly (800) comprises a press-fit ring (810) mounted on an outer circumferential surface or an inner circumferential surface of the outer ring (400), and
the sealing portion (860) is provided on one side of the press-fitting ring (810).

4. The vehicle wheel bearing of claim 3, wherein the sealing portion (860) comprises a base portion (862) attached to one side of the press-fit ring (810) and one or more sealing lips (864) formed by extending from the base portion (862).

5. The vehicle wheel bearing of claim 4, wherein the sealing lip (864) is formed as a contact-type sealing lip.

6. The vehicle wheel bearing of claim 5, wherein the sealing portion (860) is configured to be integrally formed by vulcanization on one side of the press-fitting ring (810).

7. The vehicle wheel bearing of claim 6, wherein the press-fit ring (810) comprises a mounting portion (812) that is press-fitted to the outer circumferential surface or the inner circumferential surface of the outer ring (400); a radial extension portion (814) that extends in a radial direction from the mounting portion (812); and an axial extension portion (816) that is bent and extends in the axial direction from the radial extension portion (814), and
wherein a labyrinth structure for preventing introduction of foreign substances from an outside is formed by the axial extension portion (816).

8. The vehicle wheel bearing of claim 7, wherein the base portion (862) of the sealing portion (860) attached to the axial extension portion (816) of the press-fit ring (810) is configured to be positioned adjacent to the wheel hub (200) or a washer member (900) mounted thereto to form a labyrinth structure therebetween.

9. The vehicle wheel bearing of claim 7, wherein the target ring (700) comprises a frame (710) mounted on the inner ring (300); and a sensor target (720) attached to the frame (710),
wherein the frame (710) of the target ring (700) comprises a mounting portion (712) that is press-fitted to an outer circumferential surface of the inner ring (300); a radial extension portion (714) that extends in the radial direction from the mounting portion (712); and an axial extension portion (716) that is bent and extends in the axial direction from the radial extension portion (714), and
the base portion (862) of the sealing portion (860) attached to the axial extension portion (816) of the press-fit ring (810) is configured to be adjacent to the axial extension portion (716) of the frame (710) of the target ring (700) to form a labyrinth structure therebetween.

10. The vehicle wheel bearing of claim 9, wherein a step portion (862a) having a radially concave recess structure is provided on one side of the base portion (862) of the sealing portion (860), and
wherein the axial extension portion (716) of the frame (710) of the target ring (700) is disposed to be accommodated in the step portion (862a).

11. The vehicle wheel bearing of claim 7, wherein the sensor target (720) is configured to be provided in the mounting portion (712) of the frame (710), and the sealing lip (864) of the sealing portion (860) is configured to be located inward in the radial direction from the sensor target (720).

12. The vehicle wheel bearing of claim 11, wherein the sensor assembly (800) further comprises an acceleration sensing portion (830) that detects acceleration information of the vehicle.

13. The vehicle wheel bearing of claim 12, wherein the acceleration sensing portion (830) comprises an acceleration sensor (832) that detects acceleration information of the vehicle, and the acceleration sensor (832) is configured to be provided on a printed circuit board (PCB) substrate (836) provided in the sensor assembly (800).

14. The vehicle wheel bearing of claim 13, wherein the acceleration sensor (832) is configured to be positioned further outward in an axial direction than an inner axial end of the wheel hub (200).

15. The vehicle wheel bearing of claim 14, wherein the acceleration sensor (832) is configured to be positioned outward in the radial direction from a vehicle body-side end of the outer ring (400) on which the press-fitting ring (810) is mounted.
